(19) United States
(12) Patent Application Publication
(10) Pub. No.: US 2026/0230922 A1
(43) Pub. Date: Aug. 6, 2026

(54) METHOD AND APPARATUS FOR TRIGGERING A BUFFER STATUS REPORT BASED ON CHANGE IN SENSING METRIC

(71) Applicant: InterDigital Patent Holdings, Inc., Wilmington, DE (US)

(72) Inventors: Martino FREDA, Laval (CA); Tuong HOANG, Montreal (CA); Oumer TEYEB, Montreal (CA); Ananth KINI, Conshohocken, PA (US)

(73) Assignee: InterDigital Patent Holdings, Inc., Wilmington, DE (US)

(21) Appl. No.: 19/154,738

(22) PCT Filed: Feb. 14, 2024
(86) PCT No.: PCT/US2024/015792

§ 371 Date: Aug. 7, 2025

Related U.S. Application Data
(60) Provisional application No. 63/445,578, filed on Feb. 14, 2023.

(51) Int. Cl. H04W 28/02; H04W 72/25

(52) U.S. Cl. CPC H04W 28/0278; H04W 72/25

(57) ABSTRACT

A wireless transmit/receive unit (WTRU) and methods implemented therein are described. The WTRU is in mode 2 and configured with a flexible radio bearer configured with a Uu logical channel and a sidelink logical channel. Based on a trigger to transmit a buffer status report (BSR) for one or more buffers that contain an amount of data, the WTRU determines a percentage of the amount of the data stored in the one or more buffers to report for the Uu logical channel for the flexible radio bearer based on one or more of a quality of service (QoS) configured for the flexible radio bearer, a sidelink channel busy ratio (CBR), or a type of sensing the WTRU is configured to perform. The WTRU transmits the BSR reporting the determined percentage of the data in the one or more buffers based on the determined percentage being less than one hundred percent.

### CROSS-REFERENCE TO RELATED APPLICATIONS

This application claims the benefit of U.S. Provisional Application No. 63/445,578, filed Feb. 14, 2023, the contents of which are incorporated herein by reference

### SUMMARY

A wireless transmit/receive unit (WTRU) and methods implemented therein are described. The WTRU is in mode 2 and configured with a flexible radio bearer configured with a Uu logical channel and a sidelink logical channel. Based on a trigger to transmit a buffer status report (BSR) for one or more buffers that contain an amount of data, the WTRU determines a percentage of the amount of the data stored in the one or more buffers to report for the Uu logical channel for the flexible radio bearer based on one or more of a quality of service (QoS) configured for the flexible radio bearer, a sidelink channel busy ratio (CBR), or a type of sensing the WTRU is configured to perform. The WTRU transmits the BSR reporting the determined percentage of the data in the one or more buffers based on the determined percentage being less than one hundred percent.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of a user plane protocol stack for layer 2 (L2) for a WTRU-to-Network relay;

FIG. 3 is a diagram of a control plane protocol stack for L2 for a WTRU-to-Network relay;

FIG. 4 is a diagram of a protocol view of a split bearer for dual connectivity (DC);

FIG. 5 is a diagram of a protocol stack for carrier aggregation (CA);

FIG. 6 is a diagram of an example protocol stack for multipath. Use of the carrier aggregation model directly to multipath may have some issues;

FIG. 7 is a flow diagram of an example method of reporting a BSR for a WTRU in mode 2 configured with a flexible bearer configured with a Uu logical channel (or direct path) and a sidelink logical channel (or relay path);

FIG. 8 is a flow diagram 800 of an example method of triggering Uu BSR based on a change in sensing results since the last reported BSR, implemented in a WTRU configured in multipath with mode 2;

FIG. 9 is a flow diagram 900 of an example method of triggering a dedicated SR based on a result of an event on SL, implemented in a WTRU; and

FIG. 10 is a flow diagram 1000 of an example method of triggering BSR based on an amount of data received at a split bearer, implemented in a WTRU configured in multipath with mode 2 on SL and with at least one radio bearer that can be transmitted on both paths.

### DETAILED DESCRIPTION

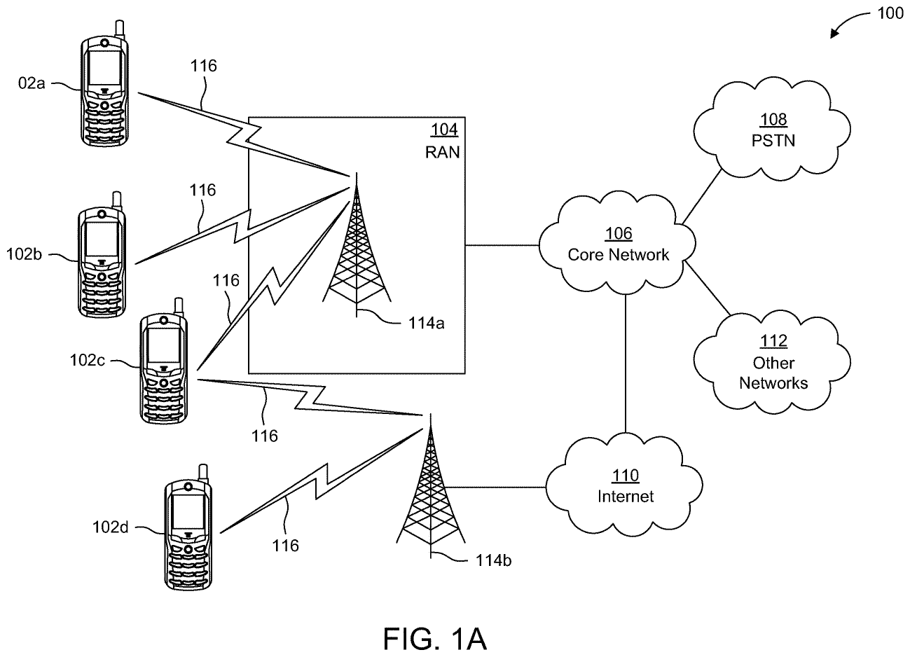

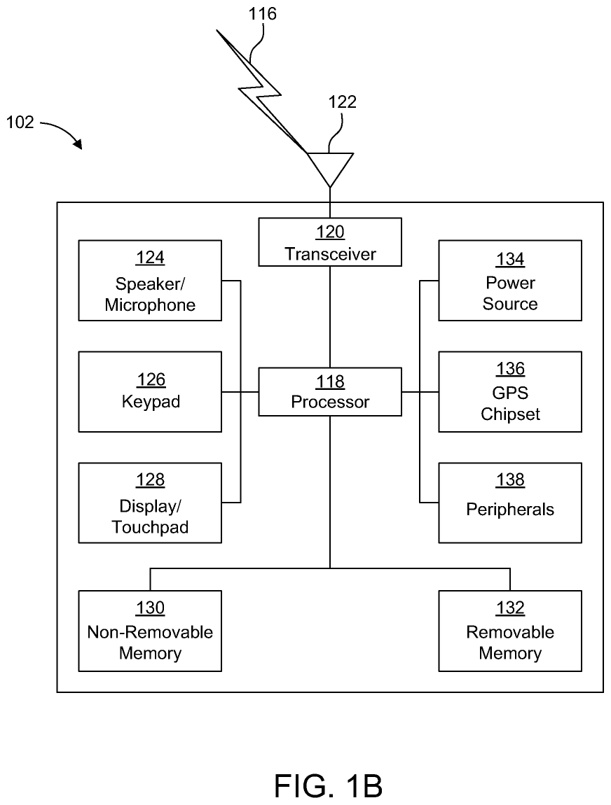

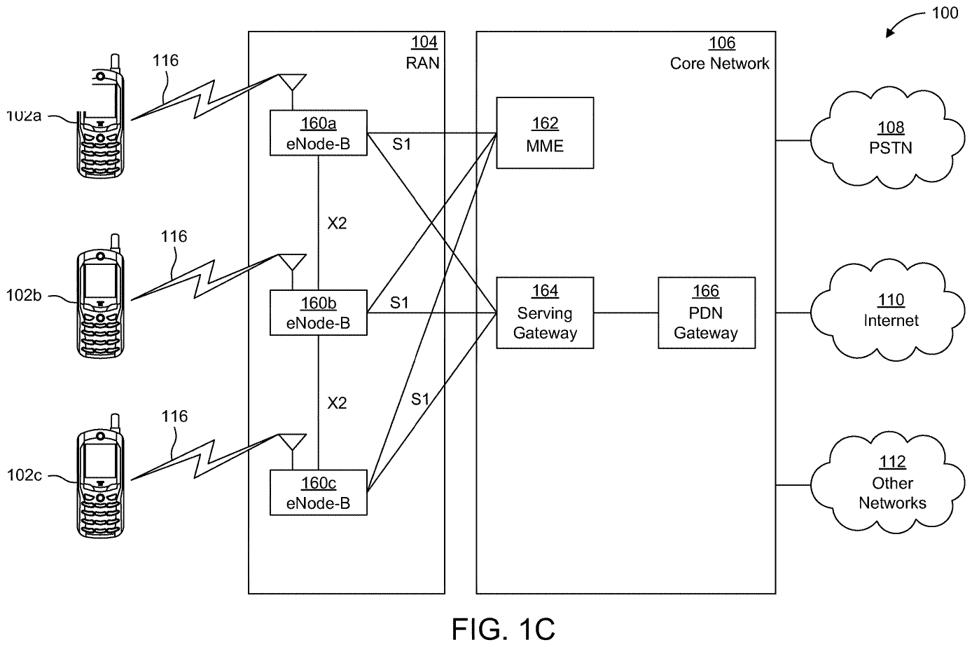

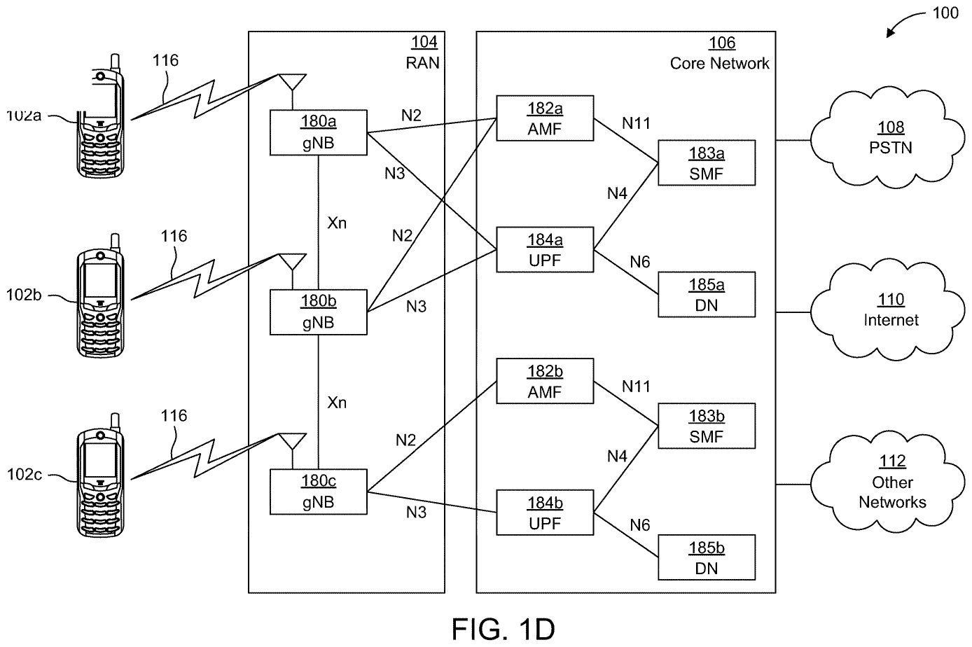

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUS 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUS 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUS 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

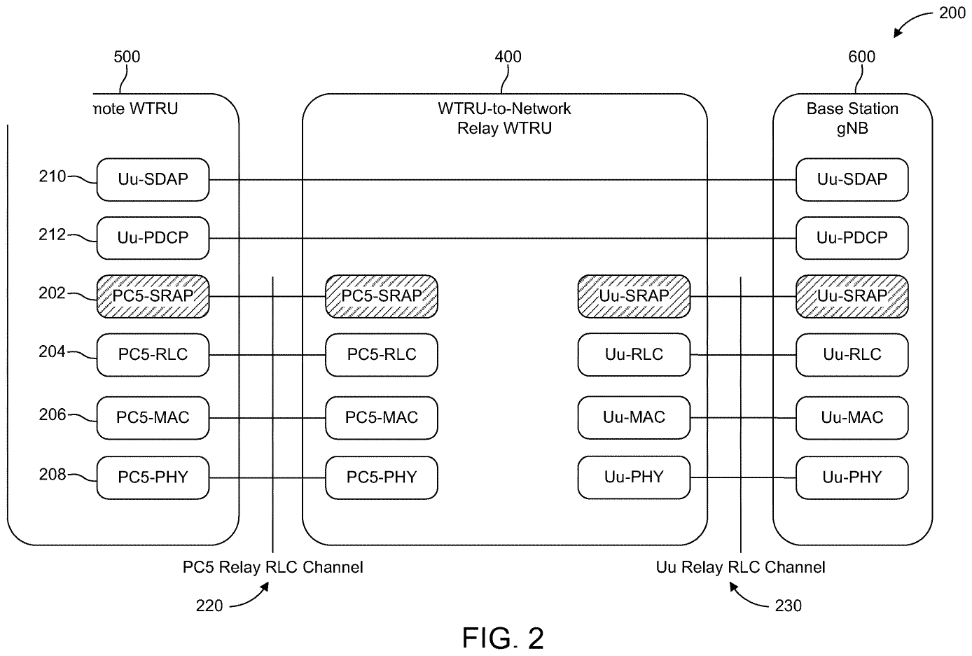

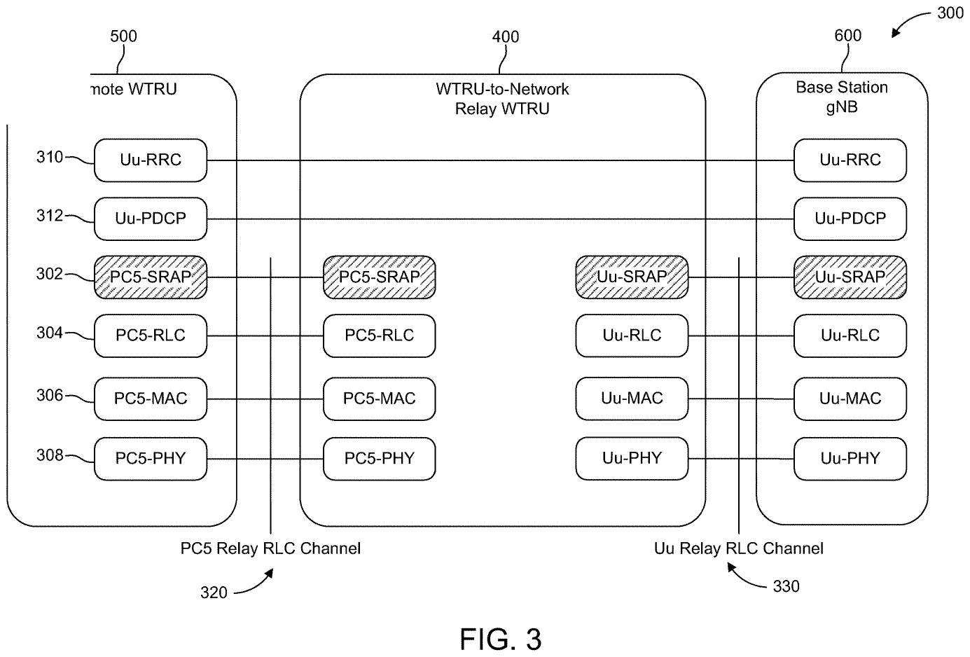

FIG. 2 is a diagram of a user plane protocol stack 200 for layer 2 (L2) for a WTRU-to-Network relay 400. FIG. 3 is a diagram of a control plane protocol stack 300 for L2 for the WTRU-to-Network relay 400. In the examples illustrated in FIGS. 2 and 3, for both the user plane 200 and the control plane 300, the Sidelink Relay Adaptation Protocol (SRAP) sublayer 202, 304 is above the Radio Link Control (RLC) sublayer 204, 304 for both at both the PC5 interface 220 and the Uu interface 230. The Uu Service Data Adaptation Protocol (SDAP) 210, Packet Data Convergence Protocol (PDCP) 212, 312 and Radio Resource Control (RRC) 310 may be terminated between the L2 U2N Remote WTRU 500 and the base station 600 (e.g., gNB), while the SRAP 202, 302, RLC 204, 304, MAC 206, 306 and physical layer (PHY) 208, 308 may be terminated in each hop, using a link between the L2 U2N Remote WTRU 500 and the L2 U2N Relay WTRU 400 and a link between the L2 U2N Relay 400 WTRU and the base station 600.

For the L2 U2N Relay 400, the SRAP sublayer 202 over the PC5 hop 220 is only for the purpose of bearer mapping. The SRAP sublayer 302 is not present over the PC5 hop 320 for relaying messages from the L2 U2N Remote WTRU 500 on the Broadcast Control Channel (BCCH) and the Paging Control Channel (PCCH). For messages from the L2 U2N Remote WTRU′ 500 on SRB0, the SRAP header is not present over the PC5 hop 220, but the SRAP header is present over the Uu hop 230 for both DL and UL.

A sidelink (SL) WTRU may be configured to operate in either mode 1 or mode 2. In mode 1, the WTRU may be scheduled on sidelink by the network, for example using Downlink Control Information (DCI) scheduling for sidelink grants. In mode 2, the WTRU may perform resource selection and/or re-selection to schedule sidelink resources.

Mode 2 resource selection may be further characterized by the potential use of sensing. A WTRU that supports sensing can use the results of sensing, or the indication of Sidelink Control Information (SCI) transmissions over a period of time that are forward booking resources, to select a set of resources for transmission. Resource selection may include determining a set of available resources based on these sensing results and comparing the observed SCIs' Reference Signal Received Power (RSRP) with a threshold that is dependent on the priority of the transmission to be made during the sensing and the transmission announced by the other SCI. If a certain percentage of resources is deemed available, a WTRU can randomly select resources, either for a single transmission, or for multiple periodic transmissions announced by a forward booking indication in the SCI, to be used for transmission. When insufficient resources are available to perform random selection, the WTRU may increase its threshold for availability by, for example, 3 dB until the sufficient amount of resources is deemed as available.

Mode 2 resource selection may be further limited by congestion control. In Mode 2, the WTRU may measure the channel busy ratio (CBR). The WTRU may be configured with some limitations in transmission based on the CBR, such as a maximum number of retransmissions, a Modulation and Coding Scheme (MCS), and/or a maximum number of subchannels, to avoid congestion being further increased when it is high. Congestion parameters may be further conditioned on the priority of a transmission such that high priority transmissions may suffer less from congestion control limitations.

The enhancements to the NR SL relay may be continued in Release 18. One of the features that may be included in discussion is the support of multi-path with relay, where a remote WTRU may be connected to the network via direct and indirect paths, which may have the potential to improve the reliability/robustness as well as throughput. Such multi-path relay may also be utilized for WTRU aggregation where a WTRU may be connected to the network via a direct path and via another WTRU using a non-standardized WTRU-WTRU interconnection. WTRU aggregation may provide applications requiring high UL bitrates on 5G terminals in cases when normal WTRUs are too limited by UL WTRU transmission power to achieve a required bitrate, especially at the edge of a cell. Additionally, WTRU aggregation can improve the reliability and stability of services, as well reducing their delay. In such situations, if the channel condition of a terminal is deteriorating, another terminal can be used to make up for the traffic performance unsteadiness caused by channel condition variation.

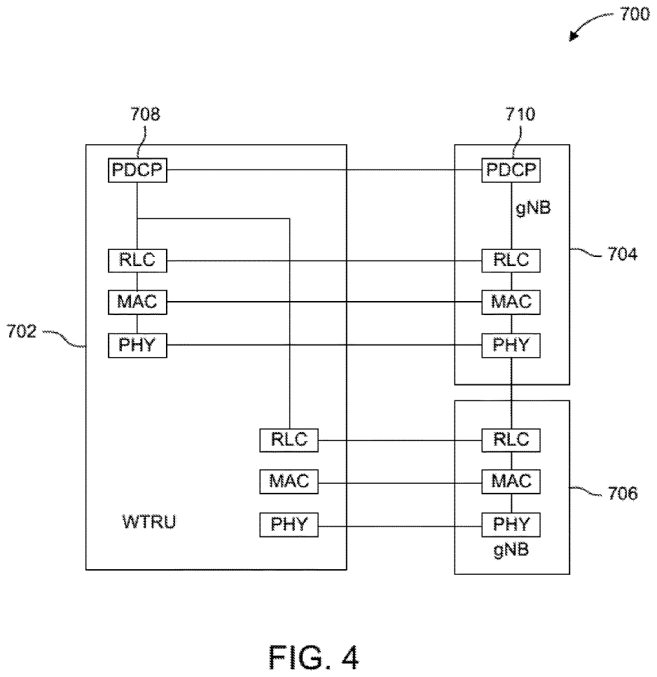

FIG. 4 is a diagram of a protocol view of a split bearer 700 for dual connectivity (DC). In DC, a WTRU 702 may be served by two nodes 704 and 706, each including a set of cells known as a Master Cell Group (MCG) and a Secondary Cell Group (SCG). A bearer can be associated with only the MCG or SCG, or can be configured as a split bearer, as shown in FIG. 4, for example.

Like any bearer, and as in the example illustrated in FIG. 4, the WTRU 702 will have one PDCP entity 708 associated with it. On the network side, the peer PDCP entity 710 is terminated at one of the gNBs (704 in FIG. 4), which may be either the master or the secondary. In the DL, the CN may send data to the gNB 704 where the PDCP is terminated, and it may be up to the network to directly send the data to the WTRU 708 via the link between the gNB 704 and the WTRU 702 or to forward the PDCP PDUs to the gNB 706, such as via an Xn interface). The gNB will send the data to the WTRU via the link between itself and the WTRU.

In the UL, the WTRU 702 may be configured with one of the paths as the primary path and the other as a secondary path. A threshold, commonly referred to as UL split buffer threshold, may also be configured. If the UL buffer size for that bearer is less this threshold, the PDCP 708 will push the data only to the RLC associated with the primary path. However, if the buffer size becomes larger than the threshold, then the WTRU can push the data to either path (e.g., left to WTRU 500 as illustrated in FIG. 3, for example).

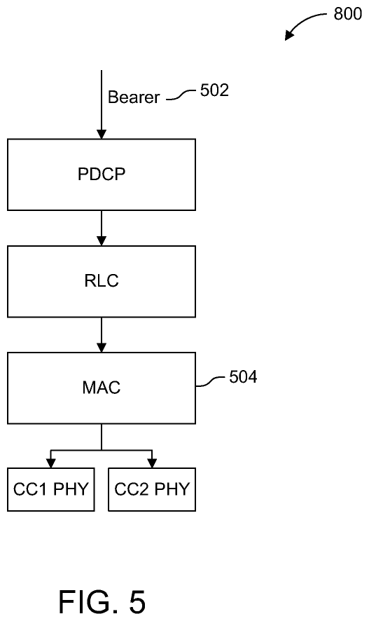

FIG. 5 is a diagram of a protocol stack 800 for carrier aggregation (CA). In CA, data in a bearer 502 can be transmitted in any carrier. A logical channel at the MAC layer 504 can send data on any of the two carriers in a flexible manner to either carrier or can be configured with a duplicate logical channel to allow CA duplication with carrier restriction.

Triggers for Uu and SL buffer status reporting (BSR) may be similar to each other. For example, a BSR may be triggered if any of the following events occur for an activated cell group: (1) uplink data for a logical channel that belongs to a logical channel group (LCG) becomes available to the MAC entity 504 and either (a) the UL data belongs to a logical channel with higher priority than the priority of any logical channel containing available UL data that belong to any LCG or (b) none of the logical channels that belong to an LCG contains any available UL data, in which case, the BSR may be referred to herein a as regular BSR; (2) UL resources are allocated and the number of padding bits is equal to or greater than the size of the BSR MAC Control Element (CE) plus its subheader, in which case the BSR may be referred to herein as a padding BSR; and/or (3) the periodicBSR-Timer expires, in which case the BSR may be referred to herein as a periodic BSR. When regular BSR triggering events occur for multiple logical channels simultaneously, each logical channel may trigger one separate regular BSR.

A WTRU may trigger resource selection and/or re-selection in mode 2 based on the following. If the transmit (TX) resource selection and/or re-selection check procedure is triggered on the selected pool of resources for a sidelink process, the MAC entity may, for the sidelink process: (1) if the Physical Sidelink Control Channel (PSSCH) and second stage SCI on the PSSCH for all transmissions of a MAC PDU of any selected sidelink grant or grants are not in SL discontinuous reception (DRX) active time of the destination that has data to be sent; or (2) if SL_RESOURCE_RESELECTION_COUNTER=0 and when SL_RESOURCE_RESELECTION_COUNTER was equal to 1 the MAC entity randomly selected, with equal probability, a value in the interval [0, 1] that is above the probability configured by RRC in sl-ProbResourceKeep; or if the pool of resources is configured or reconfigured by RRC; or (3) if there is no selected sidelink grant on the selected pool of resources; or if neither transmission or retransmission has been performed by the MAC entity on any resource indicated in the selected sidelink grant during the last second; or (4) if sl-ReselectAfter is configured and the number of consecutive unused transmission opportunities on resources indicated in the selected sidelink grant, which is incremented by 1 when none of the resources of the selected sidelink grant within a resource reservation interval is used, is equal to sl-ReselectAfter, or (5) if the selected sidelink grant cannot accommodate a RLC SDU by using the maximum allowed MCS configured by RRC in sl-MaxMCS-PSSCH associated with the selected MCS table and the WTRU selects not to segment the RLC SDU; or (6) if transmission(s) with the selected sidelink grant cannot fulfil the remaining PDB of the data in a logical channel, and the MAC entity selects not to perform transmission(s) corresponding to a single MAC PDU: clear the selected sidelink grant associated to the Sidelink process if available and trigger the TX resource selection or re-selection. If the selected sidelink grant in (5) cannot accommodate the RLC SDU, it may be left for WTRU implementation whether to perform segmentation or sidelink resource reselection. If in (6) the remaining PDB is not met, it may be left for WTRU whether to perform one or more transmissions corresponding to a single MAC PDU or sidelink resource selection. It may be left for WTRU implementation whether to trigger the TX resource selection or re-selection due to the latency requirement of the triggered MAC CE, for example.

A possible configuration for a WTRU in multipath is for the WTRU to perform SL transmission to the relay WTRU while configured in mode 2. In such case, the WTRU may be scheduled by the network on Uu, but may perform its own scheduling on the sidelink. For the bearers of the WTRU, it is clear for bearers that are configured on the Uu path or the SL path only whether the WTRU should report BSR to the network. However, what may not be clear is how to handle SR/BSR reporting for data associated with flexible bearers, specifically regarding how much data is reported in the Uu BSR to the network, and consequently, how the triggers for Uu SR/BSR may interact with the WTRU's self-scheduling of these bearers on SL in mode 2.

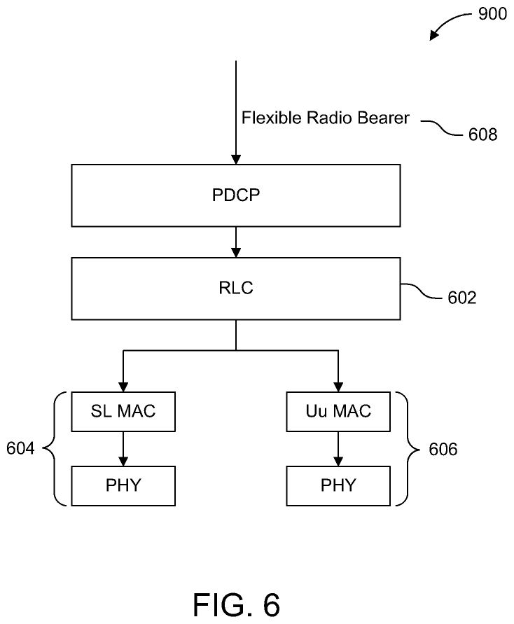

In DC, the PDCP may decide whether to push data in the MCG or SCG purely based on buffer status, and it may be up to the WTRU implementation to determine how much data to push to which RLC channel. In multipath for a remote WTRU, it may be desirable to allow a more flexible approach where data could be flexibly routed to either path depending on availability of grants (similar to carrier aggregation). Use of the carrier aggregation model directly for multipath, however, may present some issues. Specifically, it may be difficult to define a logical channel where data available for such logical channel can be flexibly transmitted to either the SL (relayed) path or the Uu (direct path) since a logical channel in Uu and a logical channel on sidelink may have very different configurations in RRC. Instead, the protocol stack for multipath assuming a more flexible (CA-based) scheduling can use an architecture such as shown in FIG. 6.

FIG. 6 is a diagram of an example protocol stack 900 for multipath. In the example illustrated in FIG. 6, a single RLC entity 602 that can flexibly send data via either the SL path or Uu path is configured with two separate logical channels 604 and 606. The SL logical channel 604 may be used for data transmissions via the indirect path, and the Uu logical channel 606 may be used for data transmissions via the direct path. The Uu logical channel 606 can be configured or behave like legacy Uu logical channels, while the SL logical channel 604 can be configured and behave like SL logical channels. Duplication can also be supported by having the RLC entity 602 transmit a PDU to both paths and both logical channels to transmit the data on their respective interface (Uu and SL). In the embodiments described herein, the following terminology may be used, considering that a split DRB mapped to the architecture illustrated in FIG. 6 may actually include two separate logical channels, which is not the case for carrier aggregation where a single logical channel is assumed. Uu RBS (e.g., for stringent latency) may be configured to transmit data via the Uu. Sidelink RBs (e.g., for long latency data) may be configured to transmit data via sidelink. Flexible RBs, such that the flexible RB 608 in FIG. 6 (e.g., for medium latency data and high reliability), may be configured to transmit data via either the Uu or sidelink based on certain conditions.

Embodiments described herein are assumed to apply predominately to flexible radio bearers, such as illustrated in FIG. 6, since they can dynamically send data over either path without the need for RRC reconfiguration. However, without loss of generality, the embodiments could be applied to Uu RBs and sidelink RBs as well.

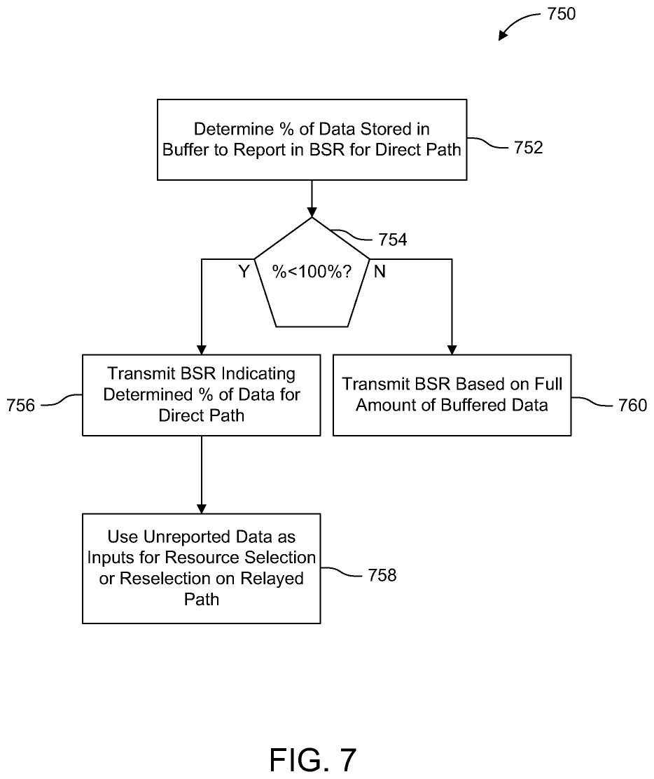

FIG. 7 is a flow diagram 750 of an example method of reporting a BSR for a WTRU in mode 2 configured with a flexible bearer configured with a Uu logical channel (or direct path) and a sidelink logical channel (or relay path). In the example illustrated in FIG. 7, a WTRU determines the amount or percentage of buffered data to report for the Uu BSR for the multipath radio bearer based on at least one sensing metric (752). The sensing metric may be or include one or more of the QoS of the bearer, SL CBR, and/or sensing type. Based on the amount or percentage of data being less than 100% (754) (or less than the entire contents of the buffer), the WTRU may transmit the BSR indicating the determined amount or percentage (756). The WTRU may assume data not reported in the BSR may be used as inputs to resource selection and/or re-selection for the SL or relayed path (758). If the determined amount or percentage of data is 100% or the full buffer contents, the WTRU may send the BSR as it normally would for a single path radio bearer (i.e., transmit the BSR based on the full amount of buffered data) (760).

A WTRU may be configured in multipath with mode 2 on SL and with at least one radio bearer that can be transmitted on both paths. Upon arrival of higher priority data at the WTRU and/or a trigger for periodic BSR, the WTRU may determine the percentage of the buffer status to report for Uu for each radio bearer based on at least one sensing metric, such as QoS, SL CBR, and/or sensing type. The sensing type may mean, for example, whether the WTRU performs partial sensing, full sensing, random selection, or has WTRU assistance. The QoS may mean the priority or latency configured for the bearer. Regarding CBR, the WTRU may, for example, select one of a number of configured percentages associated with a range of CBRs in which the measured CBR falls. The WTRU may report, for the Uu, a BSR that equals the percentage of the actual buffer status corresponding to the determined percentage for that radio bearer. The WTRU may trigger resource selection and/or re-selection, if needed, assuming the amount of data available for transmission is determined by the non-reported BSR amount. The WTRU may transmit data on SL in the selected resources if applicable.

In some embodiments, a WTRU may report a subset of the buffer status in the BSR. For example, the WTRU may report an amount that may be less than or equal to the amount of buffered data for logical channels or channel groups associated with multipath. Such may be performed for flexible bearers only. The WTRU may report the full buffer status for logical channels (LCHs)/LCGs associated with Uu RBs and may report a subset of the buffer status for flexible bearers. A WTRU may determine the subset of the buffer status or how to report it based on one or a combination of AL conditions, sensing results, indication from the relay WTRU, a QoS configured for the bearer, a QoS marking or identification associated with each PDU in the WTRU buffers, cell or group of cells controlling the remote WTRU compared to the relay, primary path, either of the bearer itself, or of another bearer (e.g., an SRB), and/or the type of SL channel (e.g., whether the sidelink is licensed or unlicensed). The SL conditions may include, for example, CBR, sensing results, SL RSRP measured with the relay WTRU and/or CR.

Regarding CBR, for example, a WTRU may determine the amount in the subset, a percentage of the total BSR to report, or the specific data to include in the buffer status based on the measured CBR. For another example, a WTRU may be configured with a percentage of the total buffer status and only report an amount corresponding to that percentage based on the measured CBR. For example, the WTRU may be configured with a table that maps a CBR range to the percentage CBR to report. Embodiments described herein that mention the use of a percentage of the buffer status may also be extended to configuring an absolute value or range of BSR amount to report. For example, for a CBR within a first configured range, the amount of buffer status reported should be such that the remainder does not exceed a configured number of bytes.

Regarding sensing results, for example, a WTRU may determine the amount in the subset, a percentage of the total BSR to report, or the specific data to include in the buffer status based on any criteria associated with sensing results. This may include sensing type, percentage of available resources, failed resource selections and/or detected pre-emptions. Regarding sensing type, for example, the ranges (e.g., of CBR or other), percentages or absolute values (e.g., for the reported buffer status) may be different depending on whether the WTRU performs mode 2 transmission with full sensing, partial sensing, random selection and/or whether the WTRU can take advantage of sensing results provided by the peer WTRU. Regarding failed resource selections, for example, the same rules may apply to the number of times the WTRU is unable to determine a sufficient percentage (e.g., x%) of resources for resource selection. Regarding detected pre-emptions, for example, the same rules may apply to the number of times the WTRU has detected a pre-emption and the WTRU.

Regarding SL RSRP measured with the relay WTRU, for example, a WTRU may be configured with a first range of SL RSRP for which a first percentage of the total buffer status is reported as the buffer status and a second range of SL RSRP for which a second percentage of the total buffer status is reported as the buffer status.

Regarding CR, for example, a WTRU may determine the amount in the subset, a percentage of the total BSR to report, or the specific data to include in the buffer status based on the measured CR, or a configured CR limit. For example, the WTRU may report buffer status where additional/more data (a larger subset) is reported in Uu BSR when the WTRU reaches the CR limit. For example, when the CR limit is reached, the WTRU may report a different percentage, or may use a different method for determining the threshold, when the CR limit is reached compared to when it is not reached.

The indication from the relay WTRU may include, for example, RRC state of the relay WTRU, flow control indication at the relay WTRU, Uu channel conditions seen by the relay WTRU, and/or indication of a handover, SL-RLF, etc., by the relay WTRU (e.g., in NotificationMessageSidelink).

Regarding RRC state of the relay WTRU, for example, such as a WTRU in RRC_IDLE/RRC_INACTIVE, the remote WTRU may report all the buffer statuses for the flexible bearer in the Uu BSR, while when the relay WTRU is in RRC_CONNECTED, the remote WTRU may report only a subset of the buffer statuses of flexible bearers in the Uu BSR. The subset may be determined using methods herein. For example, a remote WTRU may know the RRC state of a relay WTRU explicitly (using PC5-RRC signaling) or implicitly based on signaling of other parameters, behavior, etc.

Regarding flow control indication at the relay WTRU, if the relay WTRU sends a flow control message (e.g., indicating a flow control issue), or indicates the latency associated with relaying is above a threshold, the remote WTRU may report all buffer statuses associated with the flexible bearers in the Uu BSR. The relay WTRU may continue to report all the buffer statuses until another flow control message is sent indicating that the flow control issue is resolved. For example, the remote WTRU may compute a first subset (using a first set of rules herein) for a first type of flow control message received or for a period of time following a first flow control condition and may compute a second subset (using a second set of rules herein) for a second type of flow control message received or for a period of time following a second flow control condition.

Regarding Uu channel conditions seen by the relay WTRU, for example, the remote WTRU may receive an indication of the Uu channel conditions (e.g., cell level RSRP, CSI, estimated latency, estimated bandwidth) and may compute a first amount for the subset for a first condition and a second amount for the subset of a second condition.

Regarding indication of handover, SL-RLF, etc., by the relay WTRU, for example, a relay WTRU may report the entire buffer status associated with a flexible bearer following reception of a message (e.g., NotificationMessageSidelink) from the relay WTRU (e.g., indicating HO, SL RLF, etc.) in the Uu BSR. The relay WTRU may continue to report the entire buffer status in the Uu BSR until reception of another NotificationMessageSidelink or until reception of a message from the network (e.g., a reconfiguration), or indefinitely.

Regarding QoS configured for the bearer, for example, under certain conditions herein, a remote WTRU may report all of the buffer statuses for a flexible bearer if the flexible bearer is associated with certain QoS conditions (e.g., has priority larger than a threshold, is configured to do so in the bearer configuration by an explicit/implicit configuration parameter in the bearer configuration, etc.).

A QoS marking or identification associated with each PDU in the WTRU buffers may include, for example, a PDU set delay budget (PSDB) and/or a PDU set or PDU set type. For example, a remote WTRU may report only the data in its buffers for which the PSDB is below a threshold or a certain calculated amount. For another example, a remote WTRU may report only the data in its buffers for which the PDU set type is of a certain type.

Regarding cell or group of cells controlling the remote WTRU compared to the relay, for example, a remote WTRU may have a different rule for reporting the buffer status associated with the flexible bearer in the Uu BSR depending on whether the remote WTRU cell (for the direct path) is the same as the relay WTRU's cell, or in the same configured group of cells. For example, in the same cell case, the remote WTRU may report all buffer statuses in the Uu BSR, while, for the different cell case, the remote WTRU may report a subset of the buffer status (based on some rules herein). For example, in the same cell case, the remote WTRU may use a first table of percentages vs CBR, for example, while in the different cell case, the remote WTRU may use a second table.

Regarding the primary path, for example, a remote WTRU may have a different rule for reporting the buffer status associated with the flexible bearer in the Uu BSR depending on whether the primary path of that bearer or of the SRB is configured as direct or indirect.

Regarding the type of SL channel, for example, a remote WTRU may have a different rule for reporting the buffer status associated with the flexible bearer in the Uu BSR depending on whether the SL path is over a licensed or unlicensed channel. For example, for a licensed SL channel, the remote WTRU may use a first table or percentage vs CBR, for example, while in the unlicensed SL channel, the remote WTRU may use a second table.

In some embodiments, a WTRU may report a suggested split of the BSR, such as via an explicit percentage, via two separate BSR amounts (a first amount for what is suggested on Uu and a second amount for what is suggested on SL) or similar mechanism for reporting such split. The WTRU may determine the split using any of the methods described for determining the subset amount. However, the WTRU may, in addition to reporting the suggested split, report the full buffer status of the flexible bearer.

In some embodiments, a WTRU may determine the data to be used for resource selection and/or reselection (i.e., the input to the mode 2 resource selection mechanism) based on the reported amount or reported/suggested split in Uu BSR. Specifically, the WTRU may report a portion of the overall buffer status to report in the Uu BSR and may use the remaining portion as the amount of data to be input to the resource selection algorithm. Alternatively, the WTRU may determine whether data should be used as available data for resource selection and/or re-selection or not depending on whether it was reported in the Uu BSR. Specifically, if only certain data is reported in the Uu BSR, the remaining data may be used for resource selection and/or reselection.

Resource selection and/or re-selection triggers may also be dependent on such data splits. Specifically, the WTRU may provide only the data types (e.g., PDU set types) that are not reported in the buffer status in Uu BSR to the resource selection algorithm.

A WTRU may trigger Uu BSR when the mode 2 sensing metric changes by a pre-configured amount since the last reported BSR. A WTRU may be configured in multipath with mode 2 on SL and with at least one radio bearer that can be transmitted on both paths. The WTRU may determine one or more sensing metrics at the time of transmission of a Uu BSR containing data for a bearer configured on both paths. The one or more sensing metrics may be or include, for example, a percentage of available resources during resource selection, measured CBR, and/or an amount of dB needed to reach a particular % availability (e.g., 20%). The WTRU may monitor the one or more sensing metrics following each last reported BSR and may determine whether it has changed when preparing to send the next BSR. If the value of one or more of the metrics changes by a QoS-dependent configured amount, the WTRU may trigger a MAC CE transmission on Uu. The metric change may be determined based on the QoS of the most stringent flexible radio bearer with data reported in the last BSR. The WTRU may also perform one or more of calculating the buffer status and transmitting Uu BSR and/or transmitting a MAC CE indicating the change of the one or more sensing metric. The buffer status may be calculated or determined, for example, using any of the methods described above.

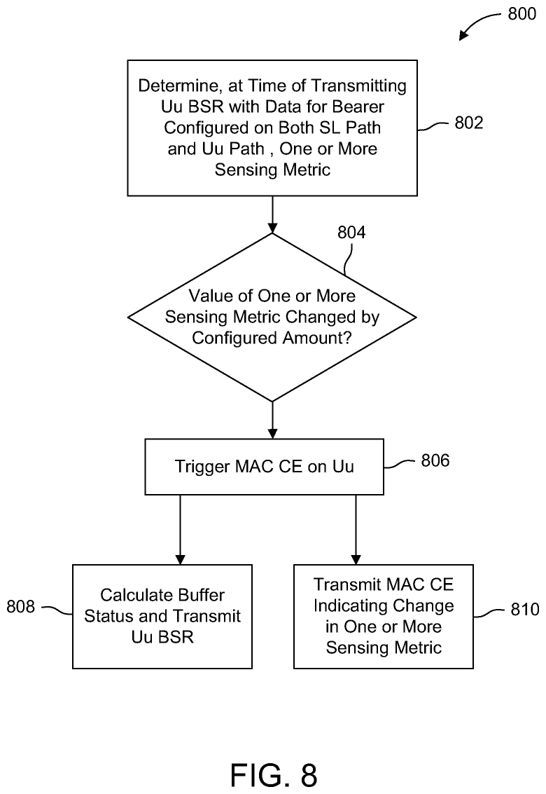

FIG. 8 is a flow diagram 800 of an example method of triggering Uu BSR based on a change in sensing results since the last reported BSR, implemented in a WTRU configured in multipath with mode 2. In the example illustrated in FIG. 8, the method includes determining, at a time of transmitting a Uu BSR comprising data for a bearer configured on both a sidelink (SL) path and a Uu path, one or more sensing metrics (802). Based on a value of one of the one or more sensing metrics changing by a configured amount that is dependent on quality of service (QoS) since a last reported BSR (804), the WTRU may trigger a (MAC) control element (CE) on the Uu (806) and perform at least one of calculating a buffer status and transmitting the Uu BSR (808) and/or transmitting the MAC CE indicating a change of the one or more sensing metric (810).

The embodiments described herein relative to triggering a BSR may apply to a WTRU in multipath. In some embodiments, the WTRU may have a multipath bearer configured and/or the WTRU may have data available for transmission on a flexible bearer. Additionally, while the embodiment described with respect to FIG. 8 mentions a WTRU configured for multipath, embodiments described herein may apply to a non-multipath WTRU for which the triggers may be for a Uu BSR and/or an SL BSR. In some embodiments, for example, a WTRU may trigger a Uu BSR as a result of a change in a measured condition on the SL. Conditions may be similar to those that trigger a change in the computed BSR or that are used to determine the amount/percentage/portion of the buffer status to report in the Uu BSR, as described in detail above. For example, a new trigger for transmitting a Uu BSR may be derived from CBR, sensing or sensing results, SL RSRP, CR, last computed percentage and/or suggested split for a Uu BSR, detection of SL radio link failure (RLF), or a combination of any of these factors. Additionally, or alternatively, the triggers just listed may be used for triggering resource selection.

When a new trigger for transmitting a Uu BSR is derived from CBR, for example, a WTRU may trigger a Uu BSR if the WTRU has data available for transmission in a flexible logical channel and the CBR: changes (e.g., increases or decreases) by a configured amount compared to the last time BSR was reported, changes (e.g., increases or decreases) by a configured amount compared to when the data arrived in the buffers, changes (e.g., increases or decreases) by a configured amount compared to the last time the WTRU computed the data split between the SL and Uu, as described herein, increases to a configured value when it was below this value previously, and/or decreases to a configured value when it was above this value previously.

When a new trigger for transmitting a Uu BSR is derived from sensing or sensing results, for example, a WTRU may trigger a Uu BSR if it detects pre-emption, which may be conditioned further on whether the WTRU can meet the latency requirement of data as a result of the pre-emption. For another example, a WTRU may trigger a Uu BSR if listen-before-talk (LBT) on SL fails, assuming the SL operates on unlicensed spectrum. For another example, a WTRU may trigger a Uu BSR if it receives sensing results or an indication from another WTRU related to sensing results, such as an indication that resources selected by the remote WTRU are being used by another WTRU. For yet another example, a WTRU may trigger a Uu BSR if the WTRU fails a number of resource selection procedures, whereby failure may equate to finding a sufficient amount (e.g., 20%) of resources available after an availability determination.

When a new trigger for transmitting a Uu BSR is derived from SL RSRP, for example, the WTRU may trigger a Uu BSR when the SL RSRP determined by the remote WTRU, or indicated by the relay WTRU to the remote WTRU, falls below a threshold.

When a new trigger for transmitting a Uu BSR is derived from CR, for example, the WTRU may trigger a Uu BSR if the CR exceeds a threshold or if the WTRU reaches the CR limit or some value of the CR from the CR limit.

When a new trigger for transmitting a Uu BSR is derived from last computed percentage and/or suggested split for a Uu BSR, for example, the WTRU may trigger a Uu BSR if it detects a change in the computed percentage split or percentage of the overall BSR to report in Uu BSR, such as by a certain amount.

When a new trigger for transmitting a Uu BSR is derived from detection of SL radio link failure (RLF), for example, the WTRU may trigger a Uu BSR if it detects SL RLF with the relay WTRU and/or it decides to maintain the relay connection.

In some embodiments, a WTRU may trigger a Uu BSR as a result of the reception of a message from a relay, and possibly a condition associated with the contents/nature of the message. Such message may be any one or more of an indication of a change in state at the relay, a discovery message, a flow control message or similar from the relay WTRU, and/or a NotificationMessageSidelink message indicating an event at the relay, such as, but not limited to: handover (HO) by the relay, relay re-selection, failure to initiate an RRC connection and/or a Uu RL indication. For example, a WTRU may trigger a Uu BSR as a result of a NotificationMessageSidelink message indicating HO by the relay. For another example, a WTRU may trigger a Uu BSR as a result of an indication from the relay WTRU that it is changing RRC state (e.g., from RRC_CONNECTED to RRC_IDLE/RRC_INACTIVE). For yet another example, a WTRU may trigger a Uu BSR when it receives a flow control message from the relay WTRU, either indicating a flow control problem at the relay WTRU to indicate a larger buffer status associated with the Uu) or indicating the alleviation of the problem to indicate a smaller buffer status associated with Uu as a result of data now being able to be routed through the sidelink.

Triggers associated with Uu BSR and/or resource selection and/or re-selection may further result in the WTRU determining whether to trigger Uu BSR only, resource selection and/or re-selection only, or both, as a result of the trigger. Such determination may be based on one or more of CBR, sensing or sensing results, sidelink RSRP, CR, QoS of the data in the buffers, a QoS marking associated with the new data, the amount of data in the buffers or the amount of new data, the last computed percentage/suggested split for Uu BSR, and/or a message (e.g., previous to the trigger) received from the relay WTRU.

In some embodiments, a WTRU may trigger either a Uu BSR or resource selection and/or reselection or may trigger both simultaneously, based on a condition. In some embodiments, the condition for deciding between Uu BSR and/or resource selection and/or reselection may be the same condition or conditions described above for determining between triggering Uu BSR or resource selection and/or reselection. For example, following a condition associated with triggering Uu BSR or resource selection and/or reselection (e.g., either a legacy trigger defined in the background or any new trigger described herein), a WTRU may further determine whether to trigger Uu BSR and/or resource selection and/or reselection based on one of the conditions described herein, such as a measured sidelink condition or a message from the WTRU.

For example, when a condition for Uu BSR and/or resource selection and/or reselection is triggered, the WTRU may determine whether to trigger Uu BSR and/or trigger resource selection and/or reselection based on the measured SL CBR. For example, if the CBR is below a threshold, the WTRU may trigger resource selection and/or reselection. Otherwise, if the CBR is above a threshold, the WTRU may trigger Uu BSR. For example, if the WTRU has data available for transmission and new data arrives that is a higher priority than any of the available data in its buffers, the WTRU may trigger Uu BSR if the CBR is above a threshold. Otherwise, the WTRU may trigger resource selection and/or reselection. For example, if the WTRU has no data available for transmission, and new data arrives, the WTRU may trigger Uu BSR if the CBR is above a threshold and resource selection and/or reselection otherwise.

For another example, when a condition (such as a legacy condition) for triggering Uu BSR is met, a WTRU may determine whether to trigger Uu BSR or to trigger resource selection and/or reselection based on last sensing results. For example, if the WTRU has experienced a number of failed sensings prior to the trigger (initially below x% of available resources) and needs to increase the RSRP threshold to achieve the x% available resources, the WTRU may trigger Uu BSR. Otherwise, the WTRU may trigger resource selection and/or reselection.

For another example, when a condition (such as a legacy condition) for triggering Uu BSR is met, a WTRU may determine whether to trigger Uu BSR or trigger resource selection and/or reselection based on the measured SL-RSRP with the relay. For example, if the SL RSRP is below a threshold, the WTRU may trigger Uu BSR. Otherwise, it may trigger resource selection and/or reselection.

For another example, when a condition (such as a legacy condition) for triggering Uu BSR is met, a WTRU may determine whether to trigger Uu BSR or trigger resource selection and/or reselection based on a QoS marking associated with the new data to transmit. For example, if the PSDB is below a threshold, the WTRU may trigger Uu BSR. Otherwise, it may trigger resource selection and/or reselection.

For another example, when a condition (such as a legacy condition) for triggering Uu BSR is met, a WTRU may determine whether to trigger Uu BSR or trigger resource selection and/or reselection based on the measured CR. For example, if the CR is above a threshold, the WTRU may trigger Uu BSR. Otherwise, it may trigger resource selection and/or reselection.

For another example, when a condition (such as a legacy condition) for triggering Uu BSR is met, a WTRU may determine whether to trigger Uu BSR or trigger resource selection and/or reselection based on a previous message received by the relay and/or a condition at the relay associated with that message. For example, if the relay WTRU indicated Uu RLF, HO, flow control problems, etc. resulting in a condition whereby the data needs to be routed via Uu for the flexible bearer, the remote WTRU, upon a legacy trigger, may trigger Uu BSR. On the other hand, if such condition resulting from a message received from the relay WTRU is resolved (e.g., HO completed, Uu RLF resolved using re-establishment, flow control issue resolved), the WTRU may trigger Uu BSR.

For yet another example, when a condition (such as a legacy condition) for triggering Uu BSR is met, a WTRU may determine whether to trigger Uu BSR or trigger resource selection and/or reselection based on the QoS of the data in the buffers or the new data triggering the event. For example, if the priority of the data is above a threshold, the WTRU may trigger Uu BSR. Otherwise, it may trigger resource selection and/or reselection. For example, the flexible bearer may be configured with whether to trigger Uu BSR or resource selection and/or reselection or further conditions related to which one to trigger.

In some embodiments, a WTRU may trigger either Uu BSR or resource selection and/or reselection at the time of the trigger based on a configuration aspect from the network. One example may be the primary path of the bearer itself. For example, the WTRU may be configured with a primary path. Upon a legacy trigger for Uu BSR and/or resource selection and/or reselection, the WTRU may trigger Uu BSR if the primary path of the bearer or of an SRB is Uu and may trigger resource selection and/or reselection if the primary path is SL/indirect.

Conditions described herein may further dictate whether to trigger both Uu BSR and resource selection and/or reselection. For example, based on the amount of new data arriving, the WTRU may decide whether to trigger either Uu BSR or resource selection and/or reselection based on the primary path configuration (in the case the amount of new data is below a threshold) or whether to trigger both Uu BSR and resource selection and/or reselection (in the case the amount of new data is above a threshold).

In some embodiments, legacy triggers for relay resource selection and/or reselection may be used to initiate Uu BSR instead of, or in addition to, relay resource selection and/or reselection. Such legacy triggers may be any of the triggers described herein and where such trigger may apply to a normal SL WTRU performing SL transmission in mode 2. For example, if a trigger occurs which, for a SL WTRU performing SL transmission in mode 2, would normally initiate resource selection and/or reselection, a WTRU in multipath may, instead of triggering resource selection and/or reselection, trigger Uu BSR instead of, or in addition to, relay resource selection and/or reselection. Such may be the case if, for example, the relay WTRU has at least one flexible bearer. Additionally or alternatively, such may be the case if, for example, the relay WTRU has data pending for a flexible bearer. Additionally or alternatively, such may be the case if, for example, the amount/QoS of the data pending for the flexible bearer meets some conditions. Similarly, in some embodiments, legacy triggers for Uu BSR may be used to trigger relay resource selection and/or reselection instead of, or in addition to, Uu BSR.

A WTRU may be configured with a dedicated SR resource and may trigger such an SR upon a condition associated with mode 2 resource selection. A WTRU configured in multipath with mode 2 on SL and with at least one radio bearer that can be transmitted on both paths may receive a configuration for a dedicated SR related to a condition associated with mode 2 resource allocation. Such receiving may be or include one or more of: triggering pre-emption for a periodic reserved resource allowing transmissions from the at least one bearer, receiving a conflict indication from a peer WTRU associated with a periodic resource allowing transmissions from the at least one bearer, experiencing SL RLF and/or receiving an SL WTRU indication from the peer WTRU (e.g., a HO). Upon the condition being met, the WTRU may transmit the dedicated Uu SR.

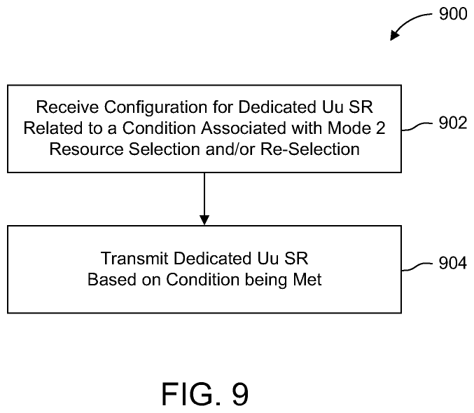

FIG. 9 is a flow diagram 900 of an example method of triggering a dedicated SR based on a result of an event on SL, implemented in a WTRU. The method may be configured in multipath with mode 2 on sidelink (SL) and at least one flexible radio bearer configured with both a Uu logical channel and a SL logical channel. In the example illustrated in FIG. 9, the WTRU may receive a configuration for a dedicated Uu SR related to a condition associated with mode 2 resource selection and/or re-selection (902). Based on the condition being met, the WTRU may transmit the dedicated Uu SR (904). Examples of receiving the configuration are described in the paragraph above and elaborated on in more detail below.

In some embodiments, a WTRU may perform a dedicated transmission to the network as a result of an event on the SL, such as when the WTRU is configured in multipath and/or when the WTRU has a flexible bearer. Such a message may be, for example, an SR, a PUCCH transmission, a RACH, a MAC CE, or an RRC message. In the embodiments described herein, a dedicated SR is assumed. However, aspects may apply to any other message.

In some embodiments, a WTRU may be configured with one or more dedicated SR resource for indicating an SL event to the network while in multipath. Alternatively, the WTRU may be configured to use one of the existing/configured SR resources (e.g., SR for the highest priority Uu LCH, SR for SL CSI reporting, etc.). In some embodiments, a WTRU may be configured with a single dedicated SR resource and may be configured with a condition for triggering SR, whereby any conditions described herein may be used. For example, the WTRU may trigger a dedicated SR if it determines a pre-emption for a periodic reserved resource allowing transmissions for at least one of the flexible bearers. For another example, the WTRU may trigger a dedicated SR if it receives a conflict indication from a peer WTRU associated with a periodic resource allowing transmissions from at least one flexible bearer. For another example, the WTRU may trigger a dedicated SR if it determines SL-RLF with the relay WTRU. For yet another example, the WTRU may trigger a dedicated SR if it receives a message from the peer WTRU (e.g., NotificationMessageSidelink) indicating, for example, a HO of the relay WTRU, Uu RLF of the relay WTRU, etc.

In some embodiments, a WTRU may be configured with multiple dedicated SR resources and may select the SR resource based on the condition evaluated. For example, the WTRU may trigger a first SR under a first condition (e.g., flow control issue) and a second SR under a second condition (e.g., SL RLF). For example, the WTRU may trigger different SRs corresponding to different levels of the issue on SL or a different amount of data required on Uu to compensate for the issue on SL. For example, the WTRU may trigger a first SR if the CBR changes by a first amount and a second SR if the CBR changes by a second amount. For example, the WTRU may trigger a first SR if it decides to change the data split by a first amount and a second SR if it decides to change the data split by a second amount.

A WTRU may trigger a Uu BSR based on the amount of new data arriving at a flexible radio bearer in a configured time period, the QoS of the bearer, and the measured CBR. A WTRU configured in multipath with mode 2 on SL and with at least one radio bearer that can be transmitted on both paths may be configured, for example by the network, with a threshold amount of new data associated with a flexible radio bearer for each QoS and CBR. The WTRU may determine a threshold amount of new data to be transmitted associated with a flexible radio bearer based on the QoS (e.g., priority) of the bearer and the CBR. If the WTRU receives an amount of new data to be transmitted for a bearer in a predefined time period that exceeds the determined threshold amount, the WTRU may trigger and/or transmit a Uu BSR to the network.

Embodiments described herein may introduce new triggers for Uu BSR and/or relay selection and/or re-selection. Such new triggers may be applied for a WTRU in multipath. Such new triggers may, for example, only be applied for data arriving at flexible bearers. Alternatively, embodiments described herein may be applied to a legacy Uu WTRU or SL WTRU when triggering Uu BSR or SL BSR, respectively, without the assumption of multipath. Legacy regular BSR may be triggered based on one or more of the following conditions: data becomes available for a logical channel with a priority that is higher than the priority of any other logical channel having data available for transmission and/or none of the logical channels has data available for transmission.

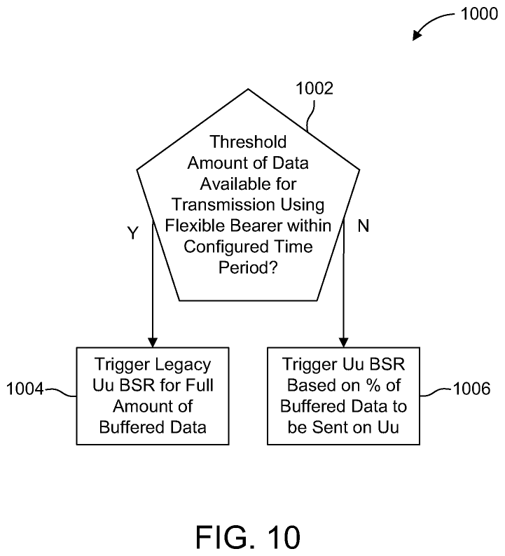

FIG. 10 is a flow diagram 1000 of an example method of triggering BSR based on an amount of new data received at a split bearer, implemented in a WTRU configured in multipath with mode 2 on SL and with at least one radio bearer that can be transmitted on both paths. Data may become available for transmission using a flexible radio bearer, and the WTRU may determine whether an amount of the data that becomes available for transmission over a configured time period exceeds a threshold amount (1002). If yes, the WTRU may trigger legacy Uu BSR for the full amount of the buffered data (1004). If not, the WTRU may trigger Uu BSR based on a percentage of the buffered data that is to be sent on Uu (1006).

In some embodiments, legacy conditions for triggering legacy or “regular” Uu BSR may be conditioned on the amount of data arriving at a logical channel. For example, a WTRU may trigger regular BSR if a minimum amount of data becomes available for a logical channel with a priority that is higher than the priority of any other logical channel having data available for transmission. The WTRU may be configured with such minimum amount of data. The configuration may further be specific to the priority (e.g., one minimum amount may be configured for a first priority and a second minimum amount may be configured for a second priority). Additionally or alternatively, such minimum amount may be conditioned on an amount of time in which the data has arrived. For example, the WTRU may trigger BSR if a minimum amount of data becomes available within a configured time window for a logical channel with a priority that is higher than the priority of any other logical channel having data available for transmission. In another example, the WTRU may trigger BSR if none of the logical channels have data available for transmission and a minimum amount of data arrives for a logical channel, possibly over a configured period of time.

In some embodiments, a new condition based on the amount of data can be added as a sole condition for triggering BSR. For example, the WTRU may trigger BSR if new data arrives at a bearer (such as a flexible bearer) and the amount of data is above a threshold. Alternatively, the WTRU may trigger BSR if new data arrives at a bearer and the amount of data that arrives in a configured time period is above a threshold.

In the above new triggers, the conditions or parameters (e.g., the amount of data that triggers BSR and/or the time window to be considered) may further depend on SL conditions and/or QoS. For example, one or a combination of the following may be used by the WTRU to determine the threshold amount of data and/or the time window: CBR, CR, SL RSRP, priority and/or QoS-related marking such as PSDB or PDU type. For example, the WTRU may be configured with a different threshold amount of data per CBR, CR, SL RSRP, priority, or any combination thereof. For another example, the WTRU may be configured with a threshold amount of data that arrives having a PSDB below a threshold, having a specific PDU type, etc. For yet another example, whether the WTRU triggers Uu BSR or not based on the arrival of a threshold amount of data may depend on a condition related to the above factors (e.g., only when CBR is above a threshold, etc.).

In some embodiments, a WTRU may trigger resource reselection based on conditions related to Uu BSR described herein. For example, a WTRU may trigger resource selection and/or re-selection when the WTRU changes the mechanism used to determine the buffer status to report in Uu BSR, possibly for the flexible bearers. For example, as a result of any trigger described herein, such as a trigger to move from reporting all of the buffer status to Uu BSR to reporting a portion of the buffer status to Uu BSR (or vice versa), the WTRU may trigger resource selection and/or re-selection. For example, a WTRU may trigger resource selection and/or re-selection when the percentage or absolute quantity of the Uu BSR to be reported changes from one quantity to another, one percentage to another, or one calculation mechanism to another. In another example, a WTRU may trigger resource selection and/or re-selection based on any of the triggers related to the amount of data arriving to a flexible bearer, such as similar to, or the same as, those triggering Uu BSR. For example, a WTRU may trigger resource selection and/or re-selection if the minimum amount of data arrives at a flexible bearer, such as over a configured time period.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method, implemented in a wireless transmit/receive unit (WTRU) in mode 2 and configured with a flexible radio bearer, the flexible radio bearer configured with a Uu logical channel and a sidelink (SL) logical channel, the method comprising:
determining to trigger a buffer status report (BSR) for a buffer containing a quantity of data;
determining a percentage of the quantity of the data in the buffer to report for the Uu logical channel based on one or more of a quality of service (QoS) configured for the flexible radio bearer, a measured SL channel busy ratio (CBR), or a type of sensing the WTRU is configured to perform; and
based on the determined percentage being less than the quantity of the data in the buffer, transmitting the BSR reporting the determined percentage of the quantity of the data in the buffer.

2. The method of claim 1, further comprising:
based on the determined percentage being less than the quantity of the data in the buffer, triggering resource selection to select resources for transmission; and
transmitting, on SL in the selected resources, the data in the buffer that was not reported in the BSR.

3. The method of claim 1, wherein the QoS configured for the flexible radio bearer comprises at least one of a priority or a latency configured for the flexible radio bearer.

4. The method of claim 1, wherein the determining the percentage of the quantity of the data in the buffer to report for the Uu logical channel based on the measured SL CBR further comprises selecting one of a plurality of configured percentages associated with a range of CBRs in which a measured CBR falls.

5. The method of claim 1, wherein the type of sensing comprises at least one of partial sensing, full sensing or assisted sensing.

6. The method of claim 1, wherein the BSR comprises one of more of a report of a quantity of a subset of the data in the buffer, the determined percentage, or the data to include.

7. A wireless transmit/receive unit (WTRU) in mode 2 and configured with a flexible radio bearer, the flexible radio bearer configured with a Uu logical channel and a sidelink (SL) logical channel, the WTRU comprising:
a processor; and
a transceiver,
wherein the processor and the transceiver are configured to determine to trigger a buffer status report (BSR) for a buffer containing a quantity of data;
wherein the processor and the transceiver are further configured to determine a percentage of the quantity of the data in the buffer to report for the Uu logical channel based on one or more of a quality of service (QoS) configured for the flexible radio bearer, a measured SL channel busy ratio (CBR), or a type of sensing the WTRU is configured to perform, and
wherein the transceiver and the processor are further configured to transmit the BSR reporting the determined percentage of the quantity of the data in the buffer, based on the determined percentage being less than the quantity of the data in the buffer.

8. The WTRU of claim 7, wherein the processor and the transceiver are further configured to:
based on the determined percentage being less than the quantity of the data in the buffer, trigger resource selection to select resources for transmission, and
transmit, on SL in the selected resources, the data in the buffer that was not reported in the BSR.

9. The WTRU claim 7, wherein the QoS configured for the flexible radio bearer comprises at least one of a priority or a latency configured for the flexible radio bearer.

10. The WTRU of claim 7, wherein the processor and the transceiver are further configured to determine the percentage of the quantity of the data in the buffer to report for the Uu logical channel based on the measured SL CBR further comprises selecting one of a plurality of configured percentages associated with a range of CBRs in which a measured CBR falls.

11. The WTRU of claim 7, wherein the type of sensing comprises at least one of partial sensing, full sensing or assisted sensing.

12. The WTRU of claim 7, wherein the BSR comprises one of more of a report of a quantity of a subset of the data in the buffer, the determined percentage, or the data to include.

13. The method of claim 1, further comprising:
based on the determined percentage being equal to the quantity of the data in the buffer, transmitting the BSR reporting the full quantity of the data in the buffer.

14. The method of claim 1, wherein the determining to trigger the BSR for the buffer is based on one or more of an arrival of higher priority data at the WTRU or a trigger for periodic BSR.

15. The method of claim 1, further comprising transmitting another BSR reporting the full quantity of the data in the buffer for logical channels associated with Uu radio bearers.

16. The WTRU of claim 7, wherein the processor and the transceiver are further configured to:
based on the determined percentage being equal to the quantity of the data in the buffer, transmit the BSR reporting the full quantity of the data in the buffer.

17. The WTRU of claim 7, wherein the processor and the transceiver are further configured to determine to trigger the BSR for the buffer based on one or more of an arrival of higher priority data at the WTRU or a trigger for periodic BSR.

18. The WTRU of claim 7, wherein the processor and the transceiver are further configured to transmit another BSR reporting the full quantity of the data in the buffer for logical channels associated with Uu radio bearers.
